(19) United States
(12) Patent Application Publication
(10) Pub. No.: US 2019/0133204 A1
(43) Pub. Date: May 9, 2019

(54) BIB WITH PROTECTIVE COLLAR

(71) Applicant: Victoria Martone Cardinale, Commack, NY (US)

(72) Inventor: Victoria Martone Cardinale, Commack, NY (US)

(21) Appl. No.: 16/183,882

(22) Filed: Nov. 8, 2018

Related U.S. Application Data
(60) Provisional application No. 62/583,107, filed on Nov. 8, 2017.

(51) Int. Cl. A41B 13/10; A41D 13/04; A41D 27/20; A41D 31/02; B32B 5/02; B32B 27/12; B32B 27/40

(52) U.S. Cl. CPC A41B 13/103; A41D 13/04; A41D 27/20; A41D 31/02; B32B 5/024; B32B 2555/00; B32B 27/40; A41D 2400/62; A41B 2400/62; B32B 2307/726; B32B 2307/7265; B32B 27/12

(57) ABSTRACT

A bib system includes a bib and a collar system. The bib includes a panel that is configured to protect clothing and includes an opening defined therethrough that is configured to receive a neck of a person. The panel has an inner surface that is configured to face the person when the bib is secured thereto and an outer surface opposite the inner surface. The collar system is secured to the inner surface of the panel about the opening and is configured to fold over clothing of the person such that a portion the clothing is isolated between the collar system and the inner surface of the bib.

### CROSS-REFERENCE TO RELATED APPLICATION

This application claims priority to, and the benefit of, U.S. Provisional Patent Application Ser. No. 62/583,107, filed Nov. 8, 2018, the entire contents of which are hereby incorporated by reference.

### BACKGROUND

### 1. Technical Field

The present disclosure relates to bibs and, more specifically, bibs including protective collars that are either integrally formed with the bib or removably attached to the bib.

### 2. Discussion of Related Art

When feeding an infant or toddler, the infant or toddler will drop food out of his/her mouth which can slide over the top of a traditional bib onto his/her clothing. The food may cause staining and wetness requiring one to change the infants clothes. This can result in ruined clothes, the need for multiple outfits per day, and/or additional laundry. In addition, when bottle feeding infants, the infant may fall asleep with milk in his/her mouth which is prone to dribble out the sides of his/her mouth. This dribbled milk may fall behind a traditional bib and down the infant's neck onto his/her clothes causing wetness. The infant must then be changed to avoid a rash or skin irritation. Similar issues may also arise when feeding elderly individuals or individuals with special needs or recovering from injuries.

There is a continuing need for a bib that provides greater protection for the clothes and/or the well-being of individuals during and after feeding.

### SUMMARY

In an aspect of the present disclosure, a bib system includes a bib and a collar system. The bib includes a panel that is configured to protect clothing. The panel includes an opening that is defined therethrough and is configured to receive a neck of a person such that the bib is secured to the person. The panel has an inner surface that is configured to face the person when the bib is secured thereto and an outer surface opposite the inner surface. The collar system is secured to the inner surface of the panel about the opening. The collar system is configured to fold over clothing of the person such that a portion of the clothing is isolated between the collar system and the inner surface of the bib.

In aspects, the collar system includes a first element and a second element. The first element may extend on a first side of the opening and the second element may extend on a second side of the opening. Each of the first and second elements may be secured to the inner surface of the panel. The first and second elements may overlap one another such that a portion of the first element is disposed between the second element and the inner surface of the panel. The overlap may be configured to be disposed on a chest of the person when the bib is secured thereto.

In some embodiments, the collar system includes a first lobe, a second lobe, and a third lobe. The first lobe may be configured to be disposed on a chest of the person when the bib is secured thereto, the second lobe may be configured to be disposed over a right trapezius of the person when the bib is secured thereto, and the third lobe may be configured to be disposed over a left trapezius of the person when the bib is secured thereto. Each of the first, second, and third lobes may be configured to fold over clothing such that a portion of clothing is isolated between the respective lobe and the inner surface of the bib. The first, second, and third lobes may be formed of a single element.

In certain aspects, the collar system is configured to extend between each trapezius to cover a chest of the person. The bib may include a polyurethane material or a cloth material.

In particular aspects, the collar system may include a first layer formed of a water-resistant or waterproof material and a second layer formed of an absorbent material. The first layer may be configured to face the clothing of the person when the portion of the clothing is isolated between the collar system and the inner surface of the bib and the second layer may be configured to face the person when the clothing is isolated between the collar system and the inner surface of the bib.

In another aspect of the present disclosure, a collar system is configured to attach to a bib that has a panel which includes an opening configured to receive a neck of a person. The collar system includes a first element that is configured to secure to an inner surface of the panel about the opening. The first element may be configured to fold over a portion of clothing of the person. The collar system that is configured to extend about a substantial portion of the opening such that an entire front of the clothing of the person is isolated between the inner surface of the panel and the collar system.

In aspects, the collar system includes a second element. The first element may extend on a first side of the opening and the second element may extend on a second side of the opening. Each of the first and second elements may be secured to the inner surface of the panel. The first and second elements may overlap one another such that a portion of the first element is disposed between the second element and the inner surface of the panel.

In some aspects, the collar system includes a first lobe, a second lobe, and a third lobe. The first lobe may be configured to be disposed on the chest of the person when the bib is secured thereto, the second lobe may be configured to be disposed over a right trapezius of the person when the bib is secured thereto, and the third lobe may be configured to be disposed over a left trapezius of the person when the bib is secured thereto. Each of the first, second, and third lobes are configured to fold over clothing such that a portion of the clothing is isolated between the respective lobe and the inner surface of the bib. The first element may include the first, second, and third lobes.

In certain aspects, the first element includes a first layer formed of a water-resistant or waterproof material and a second layer that is formed of an absorbent material. The first layer may be configured to face the clothing of the person when the clothing is isolated between the collar system and the inner surface of the bib and the second layer may be configured to face the person when the clothing is isolated between the collar system and the inner surface of the bib.

Further, to the extent consistent, any of the aspects described herein may be used in conjunction with any or all of the other aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a front view of an exemplary bib system including a collar system provided in accordance with the present disclosure;

FIG. 2 is a rear view of the bib system of FIG. 1;

FIG. 3 is a perspective view of the bib system of FIG. 1 secured to a child;

FIG. 4 is a cross-sectional view of a first element of the collar system of FIG. 1;

FIG. 5 is a rear view of another bib system including a collar system provided in accordance with the present disclosure; and

FIG. 6 is a rear view of another bib system including a collar system provided in accordance with the present disclosure.

### DETAILED DESCRIPTION

Embodiments of the present disclosure are now described in detail with reference to the drawings in which like reference numerals designate identical or corresponding elements in each of the several views. As used herein, the term “child” refers to a child or infant.

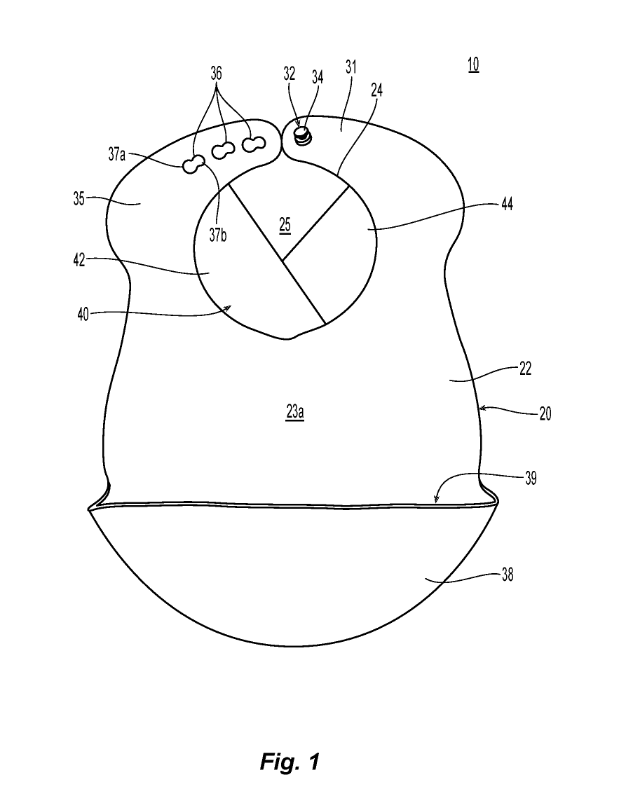

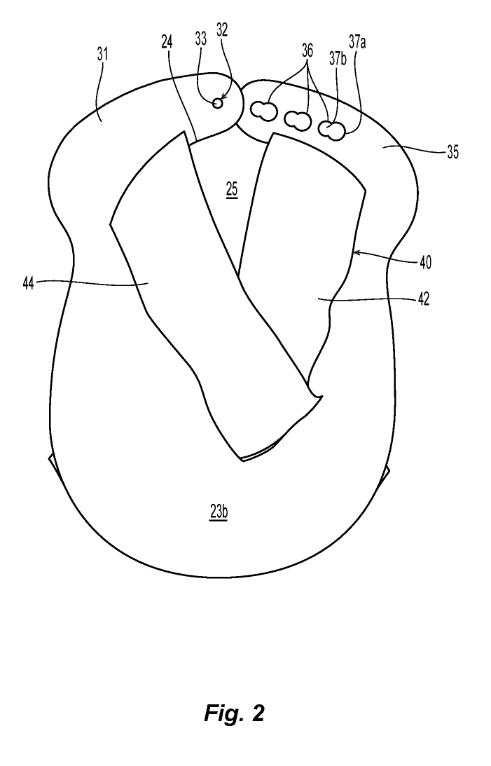

Referring now to FIGS. 1 and 2, an exemplary bib system 10 is disclosed in accordance with the present disclosure. The bib system 10 includes a bib 20 and a collar system 40. The bib 20 includes a panel 22 having an outer surface 23a and an inner surface 23b. The panel 22 includes a rim 24 that surrounds an opening 25 that is defined through the panel 22. The opening 25 is sized and dimensioned to fit around the neck of a child to secure the bib 20 to the child as detailed below. The rim 24 may be continuous requiring the panel 22 to slip over the head of the child with the head of the child passing through the opening 25. Alternatively as shown, the panel 22 may include a closure mechanism 30 that allows the bib 20 to be secured about the neck of a child without passing over the head of the child. The closure system 30 may include a grommet 32 on a first tab 31 of the panel 22 and one or more receptacles 36 on a second tab 35 of the panel 22. The grommet 32 is mushroom shaped having a head 34 and a shaft 33 and each of the receptacles 36 have a first portion 37a and a second portion 37b that are interconnected and defined through the second tab 35. The first portion 37a is sized and dimensioned to allow the head 34 to pass through the second tab 35 and the second portion 37b is sized and dimensioned to allow the shaft to pass through the second tab 35 but prevent the head 34 from passing through the second tab 35 such that the first and second tabs 31, 35 are secured together when the grommet 32 is received within the second portion 37b of one of the receptacles 36. The receptacles 36 may be spaced about the opening 25 to allow the opening 25 to have a varied dimension to accommodate a variety of neck sizes of a child depending on which one of the receptacles 36 that the grommet 32 is received within. The bib 20 may include a trough 38 that extends from the outer surface 23a of the panel and defines a basin 39 that is configured to trap items that fall out of the mouth of a child and to prevent the items from contacting clothes below the bib system 10. The trough 38 is disposed on an opposite end of the bib 20 from the opening 25. In embodiments, the bib 20 is provided without a trough 38 and/or a basin 39.

The collar system 40 is disposed about the opening 25 of the bib 20 and is configured to tuck into clothing of the child to prevent items from contacting the clothing of the child. The collar system 40 includes a first element 42 and a second element 44 which are each substantially rectangular in shape. The first and second elements 42, 44 are secured to an inner surface 23b of the panel 22 along the rim 24 of the opening 25 to form a V-shape as shown in FIG. 2. In embodiments, the first and second elements 42, 44 may be secured to the outer surface 23a of the panel 22. A portion of the first and second elements 42, 44 may overlap adjacent a lower portion of the opening 25 which is configured to be disposed on the chest of a child. The overlapping portions of the first and second elements 42, 44 may be secured to one another. For example, the overlapping portions of the first and second elements 42, 44 may be stitched together.

The V-shape of the first and second elements 42, 44 cover a substantial portion of the rim 24. Specifically, the first and second elements 42, 44 cover over 65 percent of the rim 24. In embodiments, the first and second elements 42, 44 cover between about 30 percent and about 100 percent of the rim 24.

The first and second elements 42, 44 may be secured to the inner surface 23b of the bib 22 by adhesive. In embodiments, the first and second elements 42, 44 may be integrally formed with the inner surface 23b of the bib 22. In particular embodiments, the first and second elements 42, 44 are welded, e.g., ultrasonically welded, to the inner surface 23b of the bib 22. In some embodiments, the first and second elements are secured the inner surface 23b with one or more fasteners. In certain embodiments, the first and second elements 42, 44 are stitched to the bib 22.

The first and second elements 42, 44 may be removeably attached to the inside surface 23b of the bib 22. Removeably attaching the first and second elements 42, 44 may allow for cleaning or laundering of the first and second elements 42, 44 separate from the bib 22. In embodiments, the first and second elements 42, 44 are secured to the inner surface 23b of the bib 22 by hook and loop fasteners. In certain embodiments, the first and second elements 42, 44 include a channel that releaseably receives the rib 24 to secure the first and second elements 42, 44 to the bib 20.

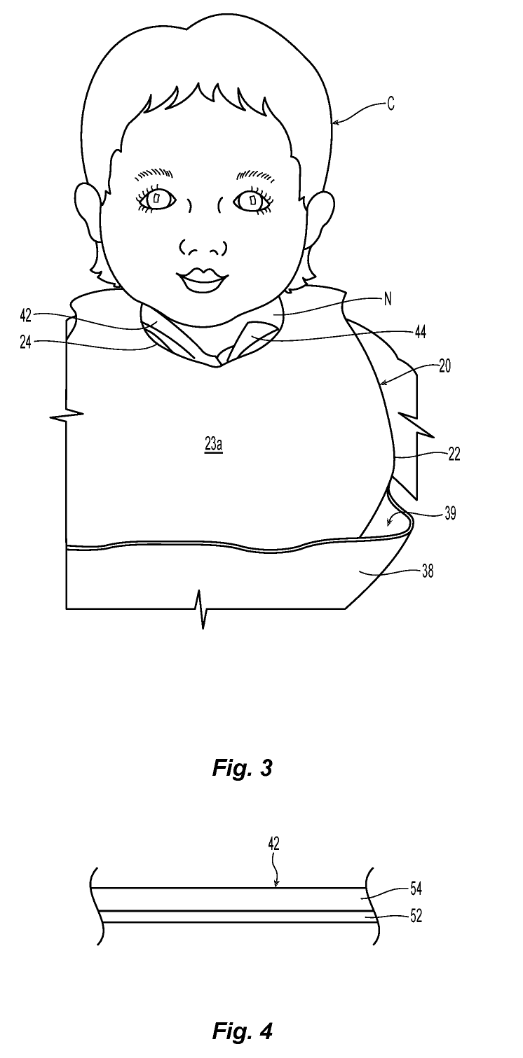

With additional reference to FIG. 3, the bib system 10 is secured about the neck N of a child C. Specifically, the grommet 32 of the closure system 40 is manipulated until the head 34 of the grommet 32 is passed through one of the receptacles 36 to secure the bib about the neck N of the child C. In embodiments with a continuous rib 24 about the opening 25, the bib 20 is passed over a head of the child C such that the head passes through the opening 25 until the bib 20 is disposed about the neck N of the child C.

When the bib system 10 is disposed about the neck N of the child C, the collar system 40 is tucked into clothes of the child C. Specifically, the first and second elements 42, 44 are tucked over a collar of a shirt of the child to position the shirt between the first and second elements 42, 44 and the inner surface 23b (FIG. 2) of the bib 20. Positioning the shirt between the first and second elements 42, 44 prevents items contacting the shirt. For example, the first and second elements 42, 44 and the bib 20 cooperate to prevent food and/or liquids from contacting the shirt of the child C. As shown, the collar system 10 extends over a substantial portion of the neck N of the child C and covers an area around the neck N between the trapezius of the child C such that the entire front of the neck N is protected.

The bib 20 may include a machine washable fabric, silicone, polyurethane, or a combination thereof. The collar system 40 may include a machine washable fabric, silicone, or a combination thereof. The bib 20 and/or the collar system 40 may be coated with nylon to allow for easy cleaning.

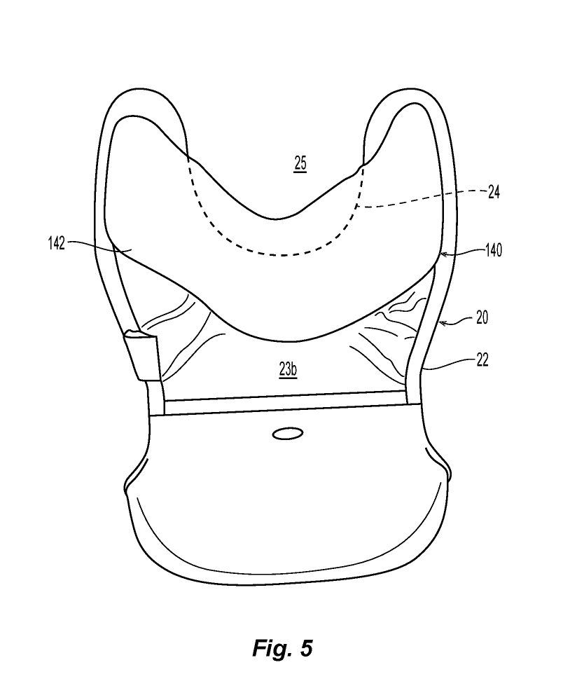

With particular reference to FIG. 4, the collar system 40 may have multilayer design to absorb liquids while preventing the liquids from contacting the clothes of the child. For example, the first element 42 may have a first layer 52 that is formed of a waterproof or water resistant material, e.g., nylon, polyurethane, or silicone, and a second layer 54 that is formed of an absorbent material and in particular may be formed of a liquid absorbent material, e.g., cotton. When in use, the first element 42 is tucked around the clothes of the child such that the second layer 54 is in contact with the skin of the child and first layer 52 is in contact with the clothes of the child. This configuration allows for the absorption of liquid or wet items that get between the bib system 10 and the child and prevents the liquids from contacting the clothes of the child.

Referring now to FIG. 5, another collar system 140 is disclosed in accordance with the present disclosure. The collar system 140 is similar to the collar system 40 detailed above with only the differences detailed below for brevity. The collar system 140 includes a single element 140 that is secured to the panel 22 of the bib 20. The element 140 extends around a substantial portion of the rib 24 such that the element extends around about 60 percent to about 100 percent of the rib 24. When in use, the element 140 protects the clothes of the child around the front and the sides of the neck of the child. In embodiments, the element 140 also protects clothes of the child around a portion of the rear of the neck of the child.

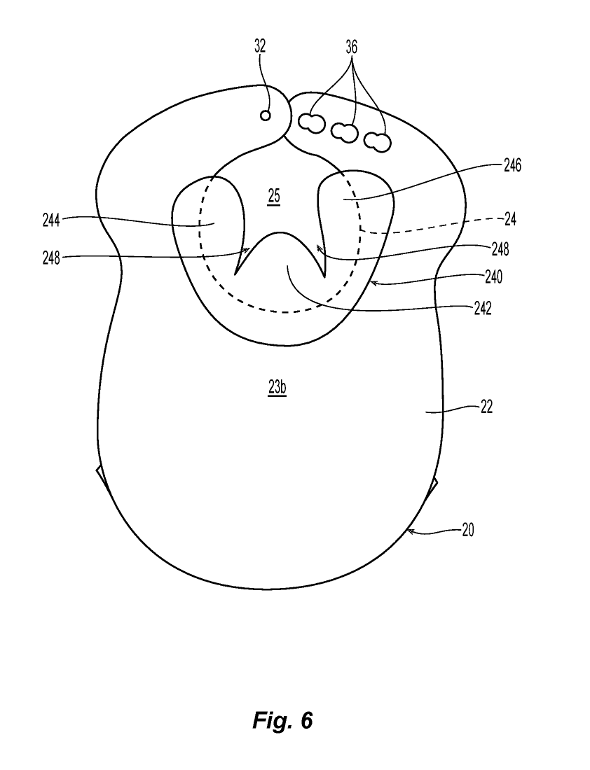

With reference to FIG. 6, another collar system 240 is disclosed in accordance with the present disclosure. The collar system 240 is similar to the collar system 40 detailed above with only the differences detailed below for brevity. The collar system 240 includes a first lobe 242, a second lobe 244, and a third lobe 246. The first, second, and third lobes 242, 244, 246 may be formed of a single element or may each be formed of a separate element. A separation 248 is defined between the first lobe 242 and the second lobe 244 and between the first lobe 242 and the third lobe 246. When the first, second, and third lobes 242, 244, 246 are formed of a single element, the separations 248 are cutouts between the respective lobes 242, 244, 246 to remove material and are disposed within a portion of the lobes 242, 244, 246 disposed within the opening 25. When the first, second, and third lobes 242, 244, 246 are formed of separate elements, the separations 248 are spaces defined between the lobes 242, 244, 246 with the lobes 242, 244, 246 overlapping each other within the opening.

In use, when the bib 20 with the collar system 240 is disposed about the neck of a child, each lobe 242, 244, 246 may be separately tucked into the clothes of the child to protect the clothes from spills. The separations 248 between the lobes 242, 244, 246 may reduce the amount of material of the collar system 240 to reduce or eliminate folds of the collar system 240 when tucked in the clothes of the child. In addition, the collar system 240 may include less material when compared to the collar systems 40, 140 detailed above which reduces the weight and/or cost of the collar system 240.

While the disclosed bib system 10 and collar systems 40, 140, 240 are discussed for use as a bib for a child, the disclosed bib system 10 and collar systems 40, 140, 240 may also be applicable to any person that requires assistance in being fed, e.g., elderly or special need individuals. Further, the disclosed bib system 10 and collar systems 40, 140, 240 disclosed herein may also be used to protect the clothing of people eating messy food items, e.g., barbeque, seafood, or during messy activities such as cooking, baking, or butchering. In addition, the disclosed collar systems 40, 140, 240 may also be used with aprons or smocks used during messy activities, e.g., cooking, baking, or butchering.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed:

1. A bib system, comprising:
a bib having a panel configured to protect clothing, the panel including an opening defined therethrough configured to receive a neck of a person such that the bib is secured to the person, the panel having an inner surface configured to face the person when the bib is secured thereto and an outer surface opposite the inner surface; and
a collar system secured to the inner surface of the panel about the opening, the collar system configured to fold over clothing of the person such that a portion of the clothing is isolated between the collar system and the inner surface of the bib.

2. The bib system according to claim 1, wherein the collar system includes a first element and a second element, the first element extending on a first side of the opening and the second element extending on a second side of the opening, each of the first and second elements secured to the inner surface of the panel.

3. The bib system according to claim 2, wherein the first and second elements overlap one another such that a portion of the first element is disposed between the second element and the inner surface of the panel.

4. The bib system according to claim 3, wherein the overlap of the first and second elements is configured to be disposed on a chest of the person when the bib is secured thereto.

5. The bib system according to claim 1, wherein the collar system includes a first lobe, a second lobe, and a third lobe, the first lobe configured to be disposed on a chest of the person when the bib is secured thereto, the second lobe configured to be disposed over a right trapezius of the person when the bib is secured thereto, and the third lobe configured to be disposed over a left trapezius of the person when the bib is secured thereto.

6. The bib system according to claim 5, wherein each of the first, second, and third lobes are configured to fold over clothing such that a portion of the clothing is isolated between the respective lobe and the inner surface of the bib.

7. The bib system according to claim 5, wherein the first, second, and third lobes are formed of a single element.

8. The bib system according to claim 1, wherein the collar system is configured to extend between each trapezius to cover a chest of the person.

9. The bib system according to claim 1, wherein the bib includes a polyurethane material.

10. The bib system according to claim 1, wherein the bib includes a cloth material.

11. The bib system according to claim 1, wherein the collar system includes a first layer formed of a water-resistant or waterproof material and a second layer formed of an absorbent material.

12. The bib system according to claim 11, wherein the first layer is configured to face the clothing of the person when the portion of the clothing is isolated between the collar system and the inner surface of the bib and the second layer is configured to face the person when the clothing is isolated between the collar system and the inner surface of the bib.

13. A collar system configured to attach to a bib, the bib having a panel including an opening that is configured to receive a neck of a person, the collar system comprising:
a first element configured to secure to an inner surface of the panel about the opening, the first element configured to fold over a portion of clothing of the person, wherein the collar system is configured to extend about a substantial portion of the opening such that an entire front of the clothing of the person is isolated between the inner surface of the panel and the collar system.

14. The collar system according to claim 13, wherein the collar system includes a second element, the first element extending on a first side of the opening and the second element extending on a second side of the opening, each of the first and second elements secured to the inner surface of the panel.

15. The collar system according to claim 14, wherein the first and second elements overlap one another such that a portion of the first element is disposed between the second element and the inner surface of the panel.

16. The collar system according to claim 13, further comprising a first lobe, a second lobe, and a third lobe, the first lobe configured to be disposed on the chest of the person when the bib is secured thereto s, the second lobe configured to be disposed over a right trapezius of the person when the bib is secured thereto, and the third lobe configured to be disposed over a left trapezius of the person when the bib is secured thereto.

17. The collar system according to claim 16, wherein each of the first, second, and third lobes are configured to fold over clothing such that a portion the clothing is isolated between the respective lobe and the inner surface of the bib.

18. The collar system according to claim 16, wherein the first element includes the first, second, and third lobes.

19. The collar system according to claim 13, wherein the first element includes a first layer formed of a water-resistant or waterproof material and a second layer formed of an absorbent material.

20. The collar system according to claim 19, wherein the first layer is configured to face the clothing of the person when the clothing is isolated between the collar system and the inner surface of the bib and the second layer is configured to face the person when the clothing is isolated between the collar system and the inner surface of the bib.
